(19) United States
(12) Patent Application Publication
(10) Pub. No.: US 2007/0013645 A1
(43) Pub. Date: Jan. 18, 2007

(54) Display method and display device

(75) Inventor: Toshio Baba, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/476,615

(22) Filed: Jun. 29, 2006

(30) Foreign Application Priority Data
Jun. 30, 2005 (JP) P. 2005-191632

(51) Int. Cl. G09G 3/36

(52) U.S. Cl. 345/102

(57) ABSTRACT

A display method includes: changing a luminance of a display device in accordance with a brightness of surroundings or an operation of a user; and changing a display form of at least one symbol to be displayed depending on the luminance of the display device.

### DISPLAY METHOD AND DISPLAY DEVICE

This application claims foreign priority based on Japanese Patent application No. 2005-191632, filed Jun. 30, 2005, the content of which is incorporated herein by reference in its entirety.

### BACKGROUND OF THE INVENTION

1. Field of the Invention

The present invention relates to a display method and a display device capable of controlling luminance, and more particularly to a display method and a display device for improving visibility by changing the display state of content to be displayed depending on the luminance.

2. Description of the Related Art

Usually, in a display device using a liquid crystal display device, in order to easily see the contents of a display such as a symbol, the luminance of the display device is ordinarily changed depending on the brightness of the surroundings. For instance, when the surroundings are bright, the luminance of the display device is increased. On the contrary, when the surroundings are dark, the luminance of the display device is lowered. The symbol indicates graphic forms, characters, or the like displayed on a display and it is an image element that can be independently controlled.

As described above, when the luminance of the display device is changed in accordance with the brightness of the surroundings, a contrast between the surroundings and the display screen can be suppressed to a low level so that the display screen can be easily viewed. (For example, refer to JP-A-2002-344598.)

However, the display device has a problem when a symbol having the same size and the same color is displayed on the display device, since as the luminance becomes lower, the human eye perceives the symbol as being smaller, and as the luminance is lowered, the visibility of the content on display is disadvantageously deteriorated.

### SUMMARY OF THE INVENTION

The present invention has been made in view of the above circumstances, and provides a display method and a display device in which the visibility of content on display does not deteriorate even when the luminance is changed in accordance with the brightness of the surroundings.

In some implementations, a display method of the invention comprises:

changing a luminance of a display device in accordance with a brightness of surroundings or an operation of a user; and

changing a display form of at least one symbol to be displayed depending on the luminance of the display device.

In the display method of the invention, the change of the display form of the symbol includes a change in a display color of the symbol.

In the display method of the invention, the change of the display form of the symbol includes a change in a shade of a display color of the symbol.

In the display method of the invention, the change of the display form of the symbol includes a change in a size of the symbol.

In the display method of the invention, the at least one symbol includes a plurality of symbols, and

the display color of each of the plurality of symbols is selected so that the plurality of symbols on a same screen has a same luminance.

In the display method of the invention, the at least one symbol includes a plurality of symbols, and

the shade of the display color of each of the plurality of symbols is selected so that the plurality of symbols on a same screen has a same luminance.

In the display method of the invention, the at least one symbol includes a plurality of symbols, and

the size of each of the plurality of symbols is selected so that the plurality of symbols on a same screen has a same luminance.

In the display method of the invention, the display form of the symbol is changed gradually in accordance with the luminance of the display device.

In some implementations, a display device of the invention comprises:

a display section;

a display control section which makes the display section display at least one symbol thereon;

a luminance control section for controlling a luminance of the display section; and

a display changing section for changing a display form of the symbol to be displayed on the display section depending on the luminance of the display section.

In the display device of the invention, the display changing section changes a display color of the symbol.

In the display device of the invention, the display changing section changes a shade of a display color of the symbol.

In the display device of the invention, the display changing section changes a size of the symbol.

In the display device of the invention, the at least one symbol includes a plurality of symbols, and

the display changing section selects the display color of each of the plurality of symbols so that the plurality of symbols on a same screen has a same luminance.

In the display device of the invention, the at least one symbol includes a plurality of symbols, and

the display changing section selects the shade of the display color of each of the plurality of symbols so that the plurality of symbols on a same screen has a same luminance.

In the display device of the invention, the at least one symbol includes a plurality of symbols, and

the display changing section selects the size of each of the plurality of symbols so that the plurality of symbols on a same screen has a same luminance.

In the display device of the invention, the display changing section includes:

a determining section for determining the luminance of the display section; and

a switching section for gradually changing the display form of the symbol in accordance with the determination result of the determining section.

As described above, the contents on display can be changed depending on whether the luminance is high or low or by an adjustment of the luminance. Therefore a display method and a display device can be realized in which the visibility of the contents of the display does not deteriorate even when the luminance of the display device is lowered.

### BRIEF DESCRIPTION OF THE DRAWINGS

FIG. 1 is a functional block diagram showing one embodiment of a display device of the present invention.

FIG. 2 is a diagram showing a luminous intensity adjusting curve of a back-light.

FIGS. 3A and 3B are diagrams showing examples comparing a symbol for the daytime with a symbol for the nighttime.

FIGS. 4A and 4B are diagrams showing examples comparing a symbol for the daytime with a symbol for the nighttime.

FIGS. 5A and 5B are diagrams showing examples comparing a symbol for the daytime with a symbol for the nighttime.

FIGS. 6A and 6B are diagrams showing examples comparing a symbol for the daytime with a symbol for the nighttime.

FIGS. 7A and 7B are diagrams showing the difference of luminance when symbols having the same form are displayed in different colors.

FIGS. 8A and 8B are diagrams showing the difference of luminance when a display color is thickened to enhance the luminance of the entire symbol.

FIGS. 9A and 9B are diagrams showing the difference of luminance when the size of the symbols is enlarged to enhance the luminance of the entire symbol.

### DESCRIPTION OF THE PREFERRED EMBODIMENTS

Now, by referring to the drawings, a display method and a display device for displaying a symbol of the present invention will be described below.

[First Embodiment]

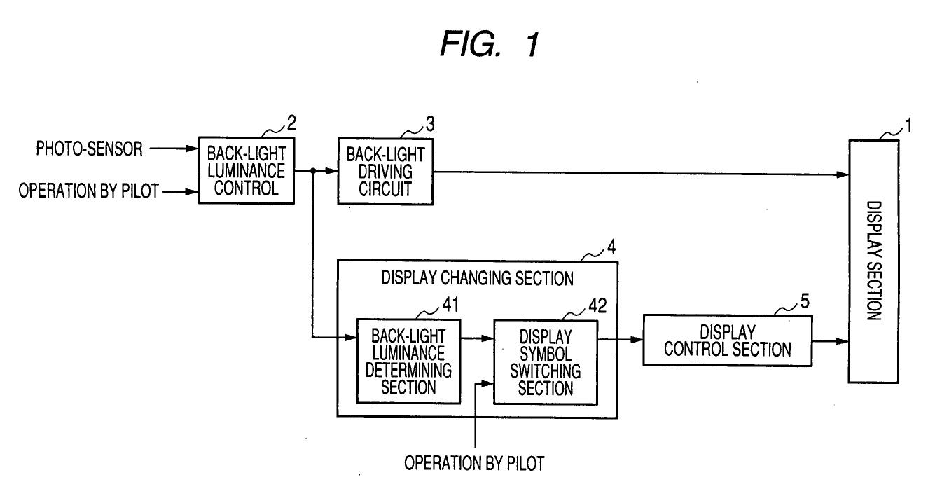

FIG. 1 is a functional block diagram showing one embodiment of the display method and the display device of the present invention. In FIG. 1, reference numeral 1 designates the display section of a liquid crystal display device. 2 designates a back-light luminance control section for setting the luminance of the back-light for the liquid crystal. 3 designates a back-light driving circuit for driving the back-light in accordance with the setting of the luminance of the back-light luminance control section 2. 4 designates a display changing section for changing the form of a display symbol. 41 designates a back-light luminance determining section for determining the luminance of the back-light. 42 designates a display symbol switching section for switching the display symbol used for displaying an image. 5 designates a display control section for controlling all the contents to be displayed on the display section 1. The device shown in FIG. 1 exemplifies a cockpit display for an aircraft.

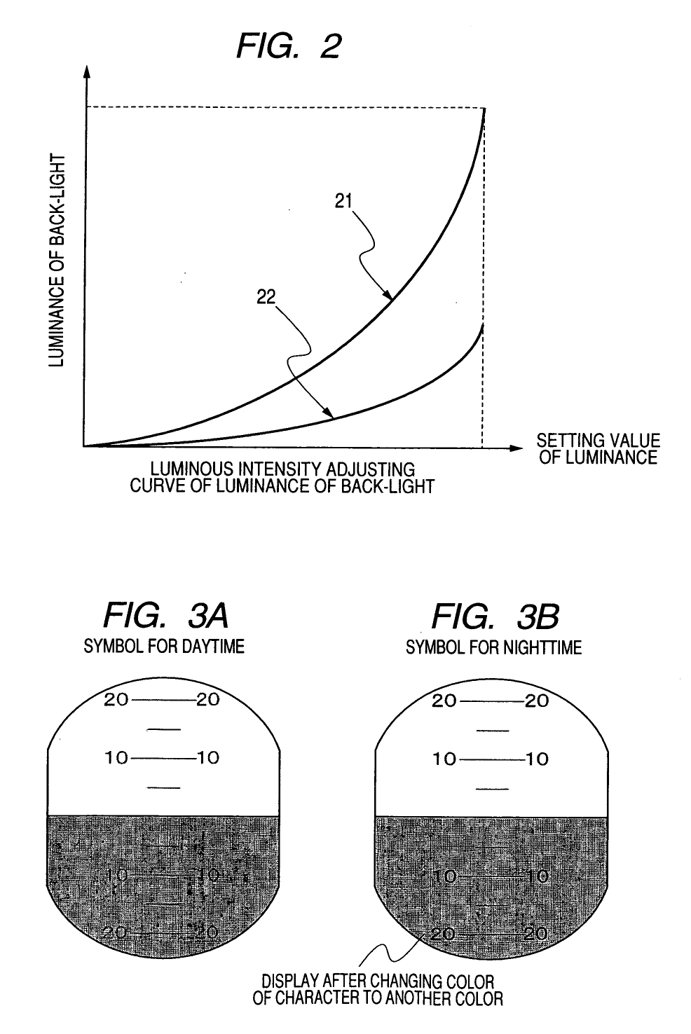

FIG. 2 shows a luminous intensity adjusting curve of the luminance of the back-light. Two kinds of luminous intensity adjusting curves including curve 21 for the daytime and curve 22 for the nighttime are prepared and stored in the back-light luminance control section 2. It is possible to switch between the luminous intensity adjusting curves in accordance with the brightness of the surroundings or the decision of a pilot. Since there is a desire to finely adjust the luminance of the back-light at night, the curve 22 for nighttime has smaller steps for changing the luminance than those in curve 21 for the daytime and the nighttime curve is more gradual.

As for the display symbol, two stages for daytime and nighttime are prepared. The symbol for the daytime is formed so that a displayed image is easily seen when the luminance of the back-light is high. The symbol for the nighttime is formed so that a displayed image is easily seen when the luminance of the back-light is low.

When the daytime luminous intensity adjusting curve 21 is used in the back-light luminance control section 2, the symbol for the daytime is used to display the image. When the nighttime luminous intensity adjusting curve 22 is used, the symbol for the daytime and the symbol for the nighttime are switched depending on the set value of the luminance of the back-light. The display symbol is switched by the display symbol switching section 42.

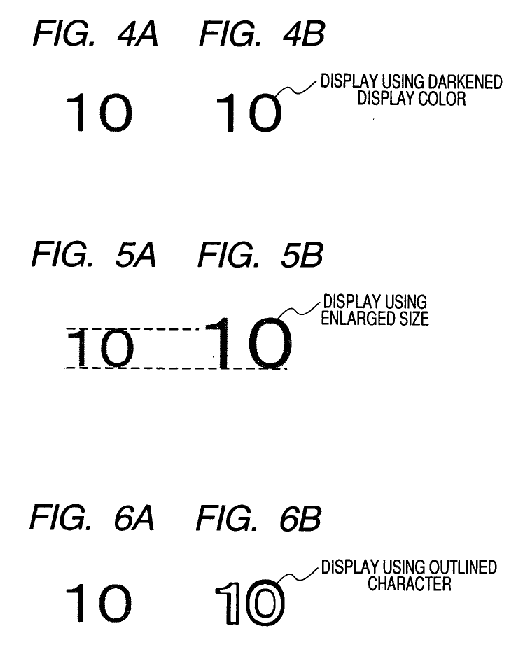

FIGS. 3A to 6B show examples of symbols for the daytime and symbols for the nighttime corresponding thereto. In FIGS. 4A to 6B, a part of a character “10” as the display, symbol shown in FIGS. 3A and 3B is shown in an enlarged form.

FIG. 3A shows the symbol for the daytime and FIG. 3B shows the symbol for the nighttime. In the symbol for the nighttime, the color of a character part is more pronounced than that of the symbol for the daytime. The color is changed to a color that can be easily seen even under situations when the surrounding is dark, so that the visibility of the character can be maintained even when the luminance of the back-light is lowered.

FIG. 4A shows the symbol for the daytime and FIG. 4B shows the symbol for the nighttime. In the symbol for nighttime, the display color of the character part is more darkened than that of the daytime symbol. The display color is darkened so that the visibility of the character can be maintained even when the luminance of the back-light is lowered.

FIG. 5A shows the symbol for the daytime and FIG. 5B shows the symbol for the nighttime. In the symbol for nighttime, the size of the character is larger than that of the daytime symbol. The size is enlarged so that the visibility of the character can be maintained even when the luminance of the back-light is lowered.

FIG. 6A shows the symbol for the daytime and FIG. 6B shows the symbol for the nighttime. In the symbol for nighttime, the character is outlined as compared to the daytime symbol. The character is outlined with a color different from the display color of the character to make the character more pronounced, so that the visibility of the character can be maintained even when the luminance of the back-light is lowered.

The symbol for the daytime and the symbol for the nighttime are automatically switched in association with the setting value of the luminance of the back-light. However, the symbol for the daytime may be directly switched to the symbol for the nighttime by an operation by the pilot.

The display symbol is not limited to the two stages for daytime and nighttime and may include three or more stages. Further, the display symbol maybe continuously switched in accordance with the luminance.

In the above-description, the present invention exemplifies a cockpit display for an aircraft. However, the present invention may be applied to other display devices that can adjust the luminance depending on the brightness of the surroundings.

[Second Embodiment]

When the luminance of a back-light is set by a manual operation of a pilot, if symbols having the same size and different colors or symbols having the same size and different forms are displayed on the same screen, since the luminance of the individual symbols is not equal, the human eye tends to adjust the luminance so that the symbol having the highest luminance is easily seen. As a result, the symbol having a lower luminance is likely to seem smaller for the human eye. As the luminance of the back-light is lowered, the visibility of the symbol having the lower luminance is thus deteriorated.

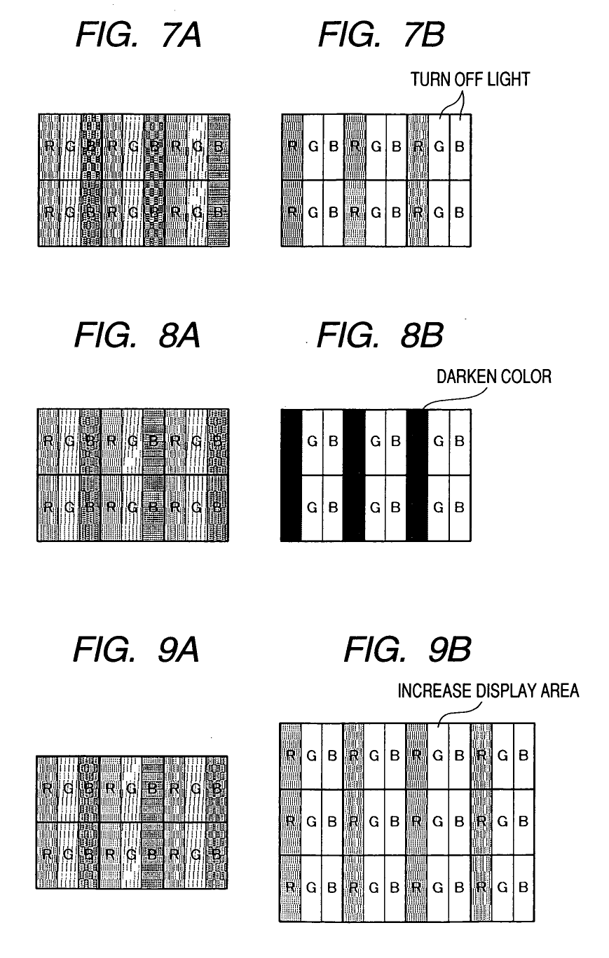

FIGS. 7A and 7B show an example comparing a case (a) with symbols having the same form (rectangle) displayed in white color with a case (b) with symbols displayed in red color. When the symbols are displayed in the white color (case a), all the colors of RGB are turned on. However, when the symbols are displayed in the red color (case b), only R is turned on and GB are turned off. Therefore, in the case of (b), the luminance of the entire symbol is lower than that in the case of (a).

When FIGS. 7A and 7B are displayed on the same screen and the luminance of the back-light is lowered, since the back-light is adjusted to the luminance of the symbols of (a) whose luminance is higher, the visibility of (b) is lower than that of (a).

FIGS. 8A and 8B show an example in which the color is displayed darker in order to raise the luminance of all the red symbols. The individual pixels (R) of the red symbols are strongly colored so that the luminance of the entire symbol is the same as the luminance of the white symbol. By making the symbols with low luminance have the same luminance as that of the symbols with high luminance, the visibility can be maintained. Furthermore, a display color (red color) can be changed to another color having a high luminance (for instance, pink), to enhance the luminance of the symbols and maintain visibility.

FIGS. 9A and 9B are an example in which the symbol size is larger in order to enhance the luminance of the entire red color symbols. The display areas of the red symbols are increased to make the luminance of the entire symbol equal to the luminance of the white symbols. By making the symbols with a lower luminance have the same luminance as that of the symbols with a higher luminance, visibility can be maintained.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A display method comprising:
changing a luminance of a display device in accordance with a brightness of surroundings or an operation of a user; and
changing a display form of at least one symbol to be displayed depending on the luminance of the display device.

2. The display method according to claim 1, wherein the change of the display form of the symbol includes a change in a display color of the symbol.

3. The display method according to claim 1, wherein the change of the display form of the symbol includes a change in a shade of a display color-of-the symbol.

4. The display method according to claim 1, wherein the change of the display form of the symbol includes a change in a size of the symbol.

5. The display method according to claim 2, wherein said at least one symbol includes a plurality of symbols, and
the display color of each of the plurality of symbols is selected so that the plurality of symbols on a same screen has a same luminance.

6. The display method according to claim 3, wherein said at least one symbol includes a plurality of symbols, and
the shade of the display color of each of the plurality of symbols is selected so that the plurality of symbols on a same screen has a same luminance.

7. The display method according to claim 4, wherein said at least one symbol includes a plurality of symbols, and
the size of each of the plurality of symbols is selected so that the plurality of symbols on a same screen has a same luminance.

8. The display method according to claim 1, wherein the display form of said symbol is changed gradually in accordance with the luminance of the display device.

9. A display device comprising:
a display section;
a display control section which makes the display section display at least one symbol thereon;
a luminance control section for controlling a luminance of the display section; and
a display changing section for changing a display form of the symbol to be displayed on the display section depending on the luminance of the display section.

10. The display device according to claim 9, wherein the display changing section changes a display color of the symbol.

11. The display device according to claim 9, wherein the display changing section changes a shade of a display color of the symbol.

12. The display device according to claim 9, wherein the display changing section changes a size of the symbol.

13. The display device according to claim 10, wherein said at least one symbol includes a plurality of symbols, and
the display changing section selects the display color of each of the plurality of symbols so that the plurality of symbols on a same screen has a same luminance.

14. The display device according to claim 11, wherein said at least one symbol includes a plurality of symbols, and
the display changing section selects the shade of the display color of each of the plurality of symbols so that the plurality of symbols on a same screen has a same luminance.

15. The display device according to claim 12, wherein said at least one symbol includes a plurality of symbols, and
the display changing section selects the size of each of the plurality of symbols so that the plurality of symbols on a same screen has a same luminance.

16. The display device according to claim 9, wherein the display changing section includes:
a determining section for determining the luminance of the display section; and
a switching section for gradually changing the display form of the symbol in accordance with the determination result of the determining section.
